(19) United States
(12) Patent Application Publication
(10) Pub. No.: US 2024/0108178 A1
(43) Pub. Date: Apr. 4, 2024

(54) Coupler Device and Methods Associated Therewith

(71) Applicant: Robert L Ballard, Birmingham, AL (US)

(72) Inventor: Robert L Ballard, Birmingham, AL (US)

(21) Appl. No.: 17/958,409

(22) Filed: Oct. 2, 2022

(51) Int. Cl. A47J 43/27; B01F 33/501

(52) U.S. Cl. CPC A47J 43/27; B01F 33/50111; B01F 2101/16

(57) ABSTRACT

A beverage coupler device is well suited for extending the use of insulated beverage containers/cups. This coupler reversibly couples two insulated containers/cups successfully into a new and improved cocktail shaker that thermally insulates the hands, decreases the condensation on the shaker, and improves the grip on the shaker. In an embodiment, a strainer may be incorporated into the coupler that allows the liquid components of a drink to pass from a first container into a second container, while restricting passage of botanicals or larger pieces of ice. The strainer may be of a size that allows the passage of small shards of ice to be incorporated into the finished drink. The process of using the strainer may enhance the aeration and texture of the beverage. While the coupler would enhance preparation of a cocktail, additional beverage applications could include a protein drink, smoothies, supplement drinks, wine, coffee and/or tea.

### FIELD OF THE INVENTION

The present invention relates to a device to couple two insulated containers/cups to provide an option for the preparation, or enhancement of a cocktail or drink. In an embodiment, the coupler of the present invention is comprised of a metallic, or plastic ring that securely couples two containers, either by inserting into the mouths of two appropriately sized insulated containers, or by having the appropriately sized insulated containers insert into the coupler.

### BACKGROUND OF THE INVENTION

Stone age jugs were discovered in the 1950s that have been carbon dated to the early Neolithic period (around 10,000 BC). It has been postulated and conjectured that these early jugs may have been used with fermented drinks (e.g., those containing ethyl alcohol) but there is insufficient proof that these jugs were used for alcoholic beverages.

More definitively, chemical analyses have recently confirmed that the earliest confirmed alcoholic beverage in the world was likely to have been a mixed fermented drink of rice, honey, and hawthorn fruit and/or grape. The residues of the beverage, dated ca. 7000-6600 BC, were recovered from early pottery from Jiahu, a Neolithic village in the Yellow River Valley in China.

Populations in Mesopotamia (around 5400 BC), in Egypt (3150 BC), in Babylon (3000 BC), in pre-historic Mexico (2000 BC), in current day Sudan (1500 BC), in Greece (100 BC), and throughout the world after 0 AD all have evidence of alcohol ingestion.

Currently, populations enjoy their alcoholic beverages cold, which is facile to do when ice is used in conjunction with the alcoholic beverage. Around 1000 BC, the Chinese recognized that food would be better preserved if it could be maintained at very low temperatures. Chinese civilization figured out a way to cut ice that was formed on top of the cold streams or snow into blocks and use it as a means of preserving food.

Frederick Tudor, a Bostonian who lived in the late 18^{th} and early 19^{th} century enjoyed ice cream and had developed the methodology of serving ice-cold drinks. He indicated and wrote that once people had tried icy-cold drinks, they could never be presented with them warm again. Over the course of the 1800s, iced drinks caught on as technical improvements for harvesting, shipping, and storing ice brought its cost down and made it more widely available.

More recently, the ubiquity of the insulated cup (or insulated containers), such as the Yeti Rambler has significantly increased providing an avenue to store iced drinks for longer periods of time. The adoption of double-walled vacuum insulation structures, and of a vacuum layer between the two stainless steel walls greatly enhances the ability of insulated structures to keep drinks cold. Moreover, the use of different metals in combination such as using stainless steel walls of the container, which may be plated with a layer of copper enhances the ability of these containers to maintain their cold temperature for longer periods of time. Moreover, providing a wider insulated area between the two walls further enhances the cooling ability. By designing structures using these simple features allows the container to prevent all heat transfer through conduction, convection or radiation and it is simply the ambient air temperature that the liquid is exposed to that allows the ice to melt. It should be understood that ice will maintain cold liquids at a given temperature (e.g., at 0° C.) longer than an equal mass of liquid at 0° C. will because the ice has to undergo a phase transition from solid to liquid that requires energy (wherein said energy is provided by the ambient air temperature around the liquid). Thus, using ice at 0° C. rather than a liquid at 0° C. is preferred to keep drinks colder longer.

Using this combination of features allows people to enjoy their drinks cold. The fictional character, James Bond, developed and written about by Ian Fleming in the 1950s embodied peoples' desire to have their alcoholic drinks served cold, when he opined that he liked his martinis “shaken, not stirred”. James Bond may have thought that by eliminating the stirrer (that may have been introduced at room temperature), he was more likely to get his martinis at a lower temperature if the shaker was uniformly cold. However, he may have been mistaken. If the top of the shaker was at a similar temperature to the stirrer, the greater surface area of the top of the shaker may have had the opposite effect that Mr. Bond desired, and he may have ended up with a warmer martini than had he simply had his martini stirred.

One additional problem of shaking mixed drinks is that the currently available shakers tend to have a top part of a shaker that has a slightly smaller circumference at its rim than the bottom part of the shaker at its rim (with the two respective parts tapering to be even narrower as one moves away from the respective rims) and the top part of the shaker is designed to fit into the bottom part of the shaker at a depth where the top part of the shaker encounters roughly the same circumference in the bottom part of the shaker and becomes essentially “fixed” (i.e., held together by friction). Once the shaker is fixed, the drink can be shaken to mix it. If the top part of the shaker is at a temperature that is different than the bottom part of the shaker, the shaker may “stick” making it difficult to remove the top part of the shaker from the bottom part of the shaker after the beverage has been shaken. When it “sticks”, the drink therein is more likely to spill as the bartender attempts to wrangle the top part of the shaker out of the bottom part of the shaker. Bar owners will not be happy if their bartenders are spilling drinks as not only is the bartender wasting alcohol, but the bartender may be forced to clean up spilled drinks thereby taking time from mixing additional drinks, all of which leads to lower profits. Similarly, anyone who is making a shaken drink (who is not a bartender) does not enjoy having their drinks spilled.

One additional problem with the current shakers is that they are not insulated so that when a person makes the drink, she/he will end up getting cold hands (or alternatively, hot hands if making a hot drink).

It is with these drawbacks in mind that the present invention was developed.

### SUMMARY OF THE INVENTION

The device of the present invention is designed and is able to serve alcoholic beverages at colder temperatures than the currently available technologies, and moreover, the present invention reduces the possibility of spillage of the alcoholic beverage. One additional advantage is that the drink can be served in a part of the shaker of the present invention and can be maintained at lower temperatures (or at hotter temperatures for hot drinks) for longer periods of time. Another advantage is that the hands of the person making the drink do not get cold (or hot for a hot drink) as the containers are insulated.

In one embodiment, the present invention relates to an insulated vacuum sealed top container (also referred to as the top part), an insulated vacuum sealed bottom container (also referred to as the bottom part), and a coupler that is able to and is configured to attach the insulated vacuum sealed top container to the insulated vacuum sealed bottom container. In an embodiment, the circumference of the rim of the insulated vacuum sealed top container, and the circumference of the rim of the insulated vacuum sealed bottom container are essentially identical in size. In an embodiment, the coupler is circular in shape, with the coupler having both an inner diameter and an outer diameter (i.e., the coupler has an opening that is defined by the inner diameter of the coupler). Similarly, the rim of insulated vacuum sealed top container and the rim of the insulated vacuum sealed bottom container are defined by an inner circumference and an outer circumference. In an embodiment, the coupler opening has a circumference that is slightly larger than the outer circumference of the rim of the insulated vacuum sealed top container, which allows the top part and bottom part to be inserted into the inner circumference of the coupler so that they fit snugly into the coupler. In an embodiment, the outer circumference of the coupler may be slightly smaller than the inner circumference of the rim of the bottom part and the inner circumference of the rim of the top part which allows the coupler to fit snuggly inside the rim of the top part and inside the rim of the bottom part.

The coupler, the top part and/or the bottom part may optionally have gaskets and/or screw threads associated with them that allows for more snug and/or more permanent affixation/attachment abilities. It should be understood that when screw threads are associated with the top part, bottom part, and the coupler, that the crest, thread angle and thread pitch are designed so that the coupler can be screwed onto and off of the top part and the bottom part. That is, if the coupler outer circumference is designed to fit inside the top part and the bottom part, the outer circumference of the coupler will have screw threads that are able to accommodate the screw threads that are present on the inner circumference of the top part and the screw threads on the inner circumference of the bottom part so that the coupler can be screwed onto the bottom part and/or the top part. Similarly, if the screw threads are on the inner circumference of the coupler, there will be screw threads on the outer circumference of the bottom part and/or the outer circumference of the top part so that the coupler can be screwed onto the top part and/or the bottom part.

### BRIEF DESCRIPTION OF THE SEVERAL VIEWS OF THE DRAWING

FIG. 1 shows a top perspective view of the various parts of the disassembled shaker of the invention.

FIG. 2 shows a top perspective view of another embodiment of the various parts of the disassembled shaker of the invention.

FIG. 3 shows a top perspective view of the various parts of the assembled shaker of the invention.

FIG. 4 shows a side view of one embodiment of the coupler of the invention.

FIG. 5 shows a top down view of the coupler of the present invention.

FIG. 6 shows a perspective view of one embodiment showing the coupler.

FIG. 7 shows a cross-sectional view from the side of the shaker wherein the shaker comprises screw threads.

FIG. 8 shows a cross-sectional view from the side of the shaker wherein the shaker comprises gaskets.

### DETAILED DESCRIPTION OF THE INVENTION

The device of the present invention is designed and is able to serve alcoholic beverages at colder temperatures than the currently available technologies, and moreover, the present invention reduces the possibility of spillage of the alcoholic beverage. One additional advantage is that the drink can be served in a part of the shaker of the present invention and can be maintained at lower temperatures (or at hotter temperatures for hot drinks) for longer periods of time. Another advantage is that the hands of the person making the drink do not get cold (or hot for a hot drink) as the containers are insulated.

In one embodiment, the present invention relates to an insulated vacuum sealed top container (also referred to as the top part), an insulated vacuum sealed bottom container (also referred to as the bottom part), and a coupler that is able to and is configured to attach the insulated vacuum sealed top container to the insulated vacuum sealed bottom container. In an embodiment, the circumference of the rim of the insulated vacuum sealed top container, and the circumference of the rim of the insulated vacuum sealed bottom container are essentially identical in size. In an embodiment, the coupler is circular in shape, with the coupler having both an inner diameter and an outer diameter (i.e., the coupler has an opening that is defined by the inner diameter of the coupler). Similarly, the rim of insulated vacuum sealed top container and the rim of the insulated vacuum sealed bottom container are defined by an inner circumference and an outer circumference. In an embodiment, the coupler opening has a circumference that is slightly larger than the outer circumference of the rim of the insulated vacuum sealed bottom container and of the outer circumference of the rim of the insulated vacuum sealed top container, which allows the top part and bottom part to be inserted into the inner circumference of the coupler so that they fit snugly into the coupler. In an embodiment, the outer circumference of the coupler may be slightly smaller than the inner circumference of the rim of the bottom part and the inner circumference of the rim of the top part which allows the coupler to fit snuggly inside the rim of the top part and inside the rim of the bottom part.

The coupler, the top part and/or the bottom part may optionally have gaskets and/or screw threads associated with them that allows for more snug and/or more permanent affixation/attachment abilities. It should be understood that when screw threads are associated with the top part, bottom part, and the coupler, that the thread angle and thread pitch are designed so that the coupler can be screwed onto and off of the top part and the bottom part. That is, if the coupler outer circumference is designed to fit inside the top part and the bottom part, the outer circumference of the coupler will have screw threads that are able to accommodate the screw threads that are present on the inner circumference of the top part and the screw threads on the inner circumference of the bottom part so that the coupler can be screwed onto the bottom part and/or the top part. Similarly, if the screw threads are on the inner circumference of the coupler, there will be screw threads on the outer circumference of the bottom part and/or the outer circumference of the top part so that the coupler can be screwed onto the top part and/or the bottom part.

In an embodiment, the use of vacuum in the insulated top part and the insulated bottom part allows for the use of different metals such as copper in combination with steel (e.g., stainless steel) that provides an excellent insulated cocktail shaker that can be reversibly attached by a coupler to each other. Because the top part and the bottom part of the shaker are insulated, they have the added advantage of not needing a towel to keep the hands warm when shaking the parts (or alternatively to protect the hands from becoming hot when being used for hot drinks). The use of insulated parts also prevents condensation on the outside of the top and bottom parts. This feature also facilitates cleaning. In an embodiment, the specific structure of the coupler ensures a tight seal and limits the potential for leaks.

In an embodiment, the present invention relates to a shaker kit that comprises the top part, the bottom part, and the coupler. In an alternate embodiment, the kit relates to a top part and the coupler or alternatively, the bottom part and the coupler. In an embodiment, the coupler can be purchased as a stand-alone device that can be used to couple commercially available containers. In a variation, if the coupler is sold as a stand-alone device, the coupler can be modified by the addition of gaskets that adapt the coupler to fit onto or into a top part and a bottom part of a shaker.

In an embodiment, the coupler may also have incorporated into it a strainer, which in one embodiment, can be used to aerate a drink, or alternatively and/or additionally to strain pieces of ice that are larger than the openings in the strainer. In an embodiment, the strainer may increase the number of small shards of ice that are able to pass into a drink-waiting container, such as in a martini. In a variation, the strainer may be able to facilitate the muddling or bruising plant material, such as mint when making a mojito or a mint julep. Presently and most often, pestles are used to crush ice and/or plant material. These devices are frequently made from stained wood, or plastic and sometimes contribute wood splinters, pieces of plastic, or wood stain into the drink. The strainer of the present invention is able to avoid these problems. In one embodiment, the coupler of the present invention is an “add on” to pre-existing insulated cups and would not necessitate purchasing a totally new shaker, although it could be initially manufactured with the improvements incorporated.

In a variation, the present invention relates to a device that allows a user to reversibly modify pre-existing insulated containers to a functional cocktail shaker that is resealable. In an embodiment, the coupler may further comprise a slip proof coating that further enhances the grip on the shaker, thereby providing the shaker with a frictioned-grip that prevents the shaker from falling when a drink is being made. In an embodiment the inner surface of the top part and the inner surface of the bottom part may optionally contain a roughing surface, thereby facilitating the fracturing of ice. The inner bottom of the bottom part and the inner bottom of the top part may also optionally contain a roughing surface that facilitates the fracturing of ice (i.e., when the top part is turned upside down to create the closed shaker, the inner bottom of the top part is actually higher in elevation than the open top of the top part as well as the coupler). The addition of a strainer on the coupler may facilitate increasing the surface area of the liquid to further aid in cooling the drink, facilitate the straining of large pieces of ice, while allowing the passage of small shards of ice, and further aerating the drink. The addition of a strainer to the coupler may also potentially decrease the presence of volatile compounds, such as aldehydes in the alcohol, when a drink is poured from either the top part or the bottom part into a receptacle into which the drink may be served.

In an embodiment, the shaker device of the present invention may also be used to rapidly cool or mix carbonated or noncarbonated soft drinks, or protein drinks and provides a suitable drinking vessel that can be used on the go. In a variation, the shaker top part and/or bottom part of the invention are of a size that allow them to fit into an automobile cup holder.

In an embodiment, the coupler is designed to be used on a hybrid glass and metal shaker. In a variation, the coupler has gaskets and/or screw threads that allow the coupler to be operationally connected to the top part and/or the bottom part that is a hybrid glass metal shaker. In an embodiment, a grid may be incorporated into the device. The grid may be blunt, contain teeth, or have a knife like edge that would fracture the ice and also act as a strainer. If the strainer has a knife-like edge, the strainer has the effect of being able to shard ice when the shaker is shaken. Thus, the shaker can be used to make smaller shards of ice that may be able to pass through the strainer. In an embodiment the shaker could be used to prepare a warm drink, such as tea. The insulated cups would provide adequate thermal protection for the preparer. A grid may also be use to separate a tea bag from warmed water and facilitate removal of the bag, or allow the drink to steep while a portion of the liquid is removed. Another embodiment would be to use the shaker to aerate wine to enhance the aroma and flavor, similar to decanting.

There exist a variety of cocktail shakers however these require purchasing a complete, or partial shaker. A further advantage of the present invention is that it has the potential to modify insulated cups that the user possibly already has into a new and improved device.

In one embodiment, the containers (e.g., tumblers) used in conjunction with the present invention adopt a double-wall vacuum insulation structure, there may be a vacuum layer between the two stainless steel walls. The inner side of the inner stainless steel wall (i.e., the side closest the drink) may be plated with a layer of copper. By employing different metals, one can greatly reduce and potentially almost prevent all heat transfer through conduction, convection or radiation. It is simply the ambient air temperature that is the greatest factor warming the drink (or alternatively, cooling a hot drink).

In an embodiment, the present invention relates to a coupling device that reversibly couples two insulated containers (e.g., cups) successfully into a new and improved cocktail shaker that thermally insulates the hands and further decreases the condensation that normally occurs on the shaker. In an embodiment, slip proof cups that have a rough surface may be used that allows a person making a drink to enhance the grip on the shaker. In an embodiment a grid (which may be similar to a strainer) may be incorporated into the device, that may be blunt, sharpened, or saw toothed, which would facilitate the fracturing of ice while also increasing the surface area of the drink allowing faster cooling. This grid would also allow the liquid components of the drink to pass from the bottom part to the top part (or vice versa) but impede ice that is larger than the grid (or strainer). In a variation, the grid would also act as a strainer to restrict botanicals, such as mint, basil or other botanicals that may be used in drinks, and large pieces of the ice, while allowing small shards of ice that are smaller than the openings in the grid to be incorporated into the finished drink. This process could further enhance the appearance or mouth feel, aerate the drink and facilitate the mixing of the drink.

While the coupler device would enhance the preparation of a cocktail, it should be understood that additional beverage applications are contemplated by the device of the present invention, including its use for protein drinks, smoothies, supplement drinks, wine, coffee or tea. In a variation, the grid may be sufficiently small so as to be able to strain coffee grounds or tea leaves while allowing the passage of the liquid. Thus, in one embodiment, the device of the present invention may be ideally suited to make tea or coffee. The features that make this possible is the ability of steeping to occur in an insulated container (meaning that the liquid does not appreciably cool while steeping occurs), and the openings in the grid are small so as to allow the passage of liquid while filtering grounds and leaves. In an embodiment, the strainer, which is operationally attached to the coupler means that it can be used with either of the top or the bottom parts. Accordingly, if one were to steep coffee or tea in the bottom part (for example for 3-5 minutes) in the fully assembled device (the bottom part, coupler, and top part are all connected), one could then invert the device, allowing the liquid tea or coffee to traverse to the top part while the strainer strains the grounds (or leaves), which remain in the bottom part. One could then release (e.g., unscrew) the top part (which contains liquid coffee or tea and is actually on the bottom) and use the top part as the coffee/tea cup, or alternatively, pour the liquid tea or coffee into another receptacle to drink. In a variation, the coupler, which comprises the strainer, can subsequently be released from the bottom part (and optionally rinsed to get rid of any grounds/leaves), and then re-attached to the top part which contains the liquid tea or coffee. The top part, which contains the liquid tea or coffee can be poured through the strainer (a second time) into a receptacle for drinking the tea or coffee. This has the effect of twice straining grounds of coffee or tea leaves, thereby ensuring that the drinker has fewer coffee grounds/tea leaves in his/her coffee or tea.

In an embodiment of the invention, both sides of the coupler would insert into the open end of appropriately sized insulated containers (e.g., cups) that in an embodiment, would be sealed by gaskets that may be formed from a compressible elastomeric material. Contemplated compressible materials include silicone based materials, isoprene based materials, nitrile rubber materials, fiberglass based materials, paper based materials, polytetetrafluoroethylene based materials, and polychlorotrifluoroethylene based materials. It should be understood that other suitable polymeric materials may be used. Generally, those materials that have good compressability under both hot and cold conditions, retain their shape over long periods, and do not suffer from degradation from exposure to hot and cold solvents are the materials that will be preferred.

In an embodiment, the circumference of the coupler or the circumference of the tops of the top part and bottom part may be enhanced with a texture such as knurling that would facilitate grip and thereby the insertion and separation of the containers from the coupler. In a variation, the coupler may be comprised of several different materials. For example, the outer circumference of the coupler may be produced at separate times and may be made of a material such as stainless steel, whereas, the inner circumference of the coupler may be manufactured out of plastic, or alternatively a different metal such as aluminum. This would have the effect of not only giving the coupler a more aesthetically pleasing appearance, but would also optionally provide extra mass or durability to the finished product.

It should also be understood that the containers may not necessarily be of the same shape and size. Both containers (i.e., the top part and the bottom part) may be tapered or one may be tapered and the other not tapered. Alternatively, neither container may be tapered. The sizes of the top part and the bottom part may be of different volumes, or alternatively, they may be of the same volume.

In an embodiment, the ends of the coupler device may be modified so as to accommodate different sizes or orifice configurations of the containers (e.g., cups). It should be understood that the coupler may be manufactured so as to have screw threads that are the same on both the upper and lower sides of the coupler so as to attach to a top part and a bottom part that are the same. Alternatively, the coupler may have different screw threads on each of its upper and lower side so as to accommodate different containers on each side. Similarly, if the top part and the bottom part are to fit inside the inner circumference of the coupler, the inner circumference on the upper side and the lower side of the coupler may be the same or different, allowing the coupler to attach to the same or different containers. If the coupler is made to fit inside the top part and the bottom part, the outer circumference of the upper and lower side of the coupler may be the same or different so as to accommodate the same or different containers.

In an embodiment, a valve, or valve like device may also be incorporated into the coupler so as to relieve pressure or potentially a vacuum, which may result from the melting of the ice that has increased the volume when compared to the resulting liquid water. The valve may have the consequence of equalizing pressure between the inside and outside of the shaker, thereby facilitating its disassembly.

The device (i.e., coupler) itself could be manufactured using a molding process, such as injection molding or fabricated from a plastic, metal, or alloys, such as stainless steel, or aluminum. The device should be made of components that are food grade quality, impact resistant and amenable to common household cleaning. The device of the invention should also be of reasonable weight so as to not fatigue the user during the shaking process, but also of sufficient weight so as to assure its durability.

The present invention will now be described with reference to the drawings.

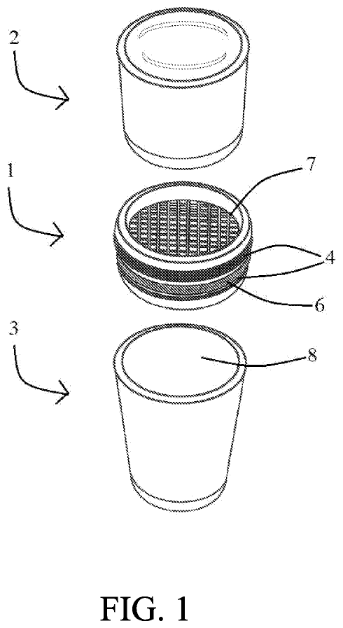

FIG. 1 shows a perspective view of the various parts of the disassembled shaker of the invention. The coupler 1 is able to couple the top part 2 with the bottom part 3. Top part 2 and bottom part 3 are, in an embodiment, insulated containers that are of a size that they are able to accommodate the coupler 1. Coupler 1 is shown with one or more gasket(s) 4 that is/are designed to snugly and securely fit inside the opening of top part 2. An additional gasket 4 may be present on coupler 1 that is designed to snugly and securely fit inside opening 8 of the bottom part 3 thereby attaching the top part 2 to the coupler 1, which is further attached to the bottom part 3. The coupler 1 is also shown with knurled edging 6 thereby facilitating a user's grip on the coupler 1. The coupler 1 is also shown with strainer 7, which performs the function of the strainer described herein. It should be understood that the strainer 7 may have different size openings allowing than shown thereby being able to strain out different things. As discussed infra, if the device is to be used for coffee or tea, the openings in the strainer should be small so as to prevent coffee grounds and/or tea leaves from being able to pass through the strainer.

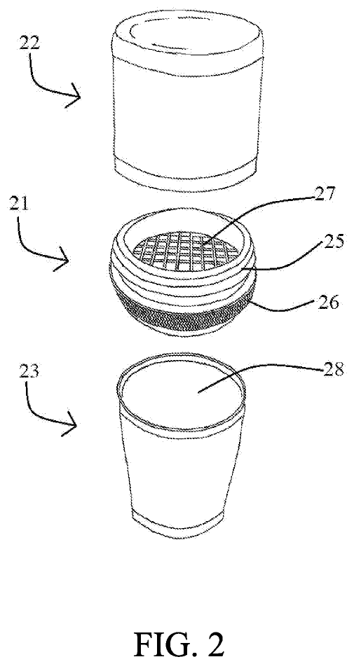

FIG. 2 shows a perspective view of another embodiment of the various parts of the shaker of the invention. The coupler 21 is able to couple the top part 22 with the bottom part 23. Top part 22 and bottom part 23 are, in an embodiment, insulated containers that are of a size that they are able to accommodate the coupler 21. Coupler 21 is shown with screw threads 25 that are designed to screw into the accommodating reciprocal screw threads (not shown) that are inside the opening of top part 22. The coupler 21 may have a gasket 4 (not shown with it) that may be present on coupler 21 that is designed to snugly and securely fit inside opening 28 of the bottom part 23 thereby attaching the top part 22 to the coupler 21 by screw thread means, which is further attached to the bottom part 23, by a gasket to generate a snug frictional fit. Alternatively, the coupler 21 may also have screw threads on the lower half of the coupler 21 (not shown) that allow the coupler to be screwed into accommodating reciprocal screw threads (not shown) that appear in opening 28 on the inner circumference of bottom part 23 allowing the coupler 21 to also be screwed into the bottom part 23. The coupler 21 is also shown with knurled edging 26 thereby facilitating a user's grip on the coupler 21. The coupler 21 is also shown with strainer 27, which performs the function of the strainer described herein.

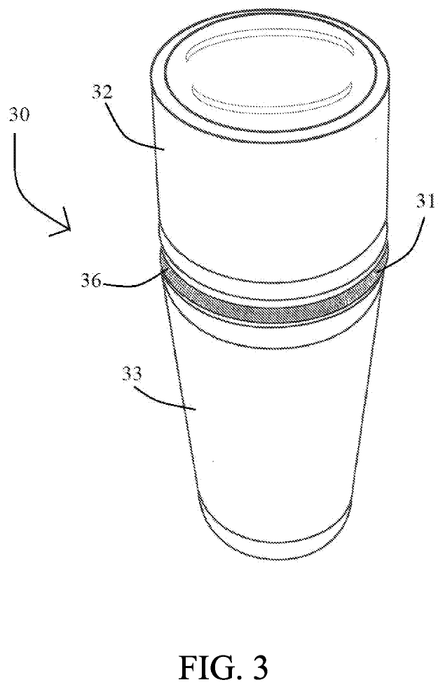

FIG. 3 shows a perspective view of the various parts of the assembled shaker 30 of the invention. The coupler 31 is able to couple the top part 32 with the bottom part 33. Top part 32 and bottom part 33 are, in an embodiment, insulated containers that are of a size that they are able to accommodate the coupler 31. Coupler 31 is shown snugly fit inside the top part 32 and the bottom part 33. It should be understood that this assembled shaker 30 can be attached via the gaskets described above or the screw threads discussed above, or a combination of the two. The coupler 31 is also shown with knurled edging 36 thereby facilitating a user's grip on the coupler 31, preventing the drink maker from dropping the shaker 30. This figure show that top part 32 is of a different shape with the shape of the container not being tapered than the bottom part 33, which shows a tapered container. Similarly, the volume capacity of the top part 32 may be different from the volume capacity of the bottom part 33.

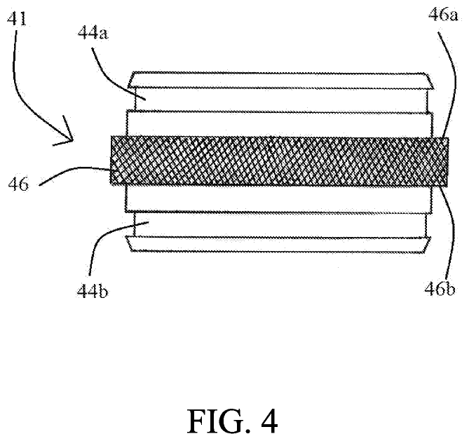

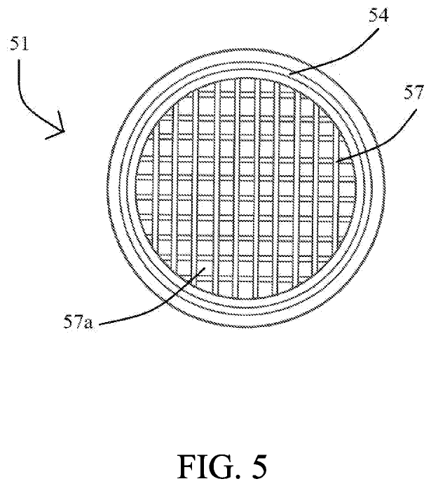

FIG. 4 shows a side view of one embodiment of the coupler 41 of the invention. The side view of the coupler 41 shows knurled edging 46 that facilitates a user's grip on the coupler 41. Slots 44a and 44b may have gaskets (not shown) added to these slots (44a and 44b) that allow the coupler 41 to be coupled to the top part and the bottom part, with the gasket that is positioned at slot 44a being used to accommodate and couple to the top part and the gasket that is positioned at slot 44b used to accommodate and couple to the bottom part. One part of knurled edging 46 that should be noted is horizontal ledge 46a that is designed to accommodate the to inner circumference at the opening of the top part. That is, horizontal ledge provides a circular ledge that is of a size that is slightly larger the inner circumference of the top part. Accordingly, the edge of the top part sits flush with horizontal ledge 46a (this can be seen in FIG. 3). Similarly, horizontal ledge 46b performs the same relative function with respect to the bottom part of the shaker. In FIG. 4, coupler 41 is a male part that is designed to be inserted into the top part and the bottom part. In contrast, the coupler in FIG. 5 is a female part that is designed to have the top part and the bottom part fit into the coupler 51.

FIG. 5 shows a top down view of the coupler 51 of the present invention. Region 54 has either a gasket associated with it or screw threads associated with it that allows top part to be coupled to the coupler 51. If region 54 comprises a gasket, the top part is snugly inserted into it and remains snugly coupled to the coupler 51 by frictional force. If region 54 comprises screw threads, then the top part will have the accommodating reciprocal screw threads that are designed to screw into region 54. The top down view of coupler 51 also reveals strainer 57. As described herein, the strainer has holes 57a in the strainer that may be any of a plurality of sizes depending on what one wants to filter. The holes 57a as they are shown in FIG. 5 may be designed to filter larger ice cubes and botanical plant matter. If one wants to filter coffee grounds or tea leaves, the holes 57a may be significantly smaller. In any event, the holes 57a should be of a size that at least allows the liquid drink to pass through them.

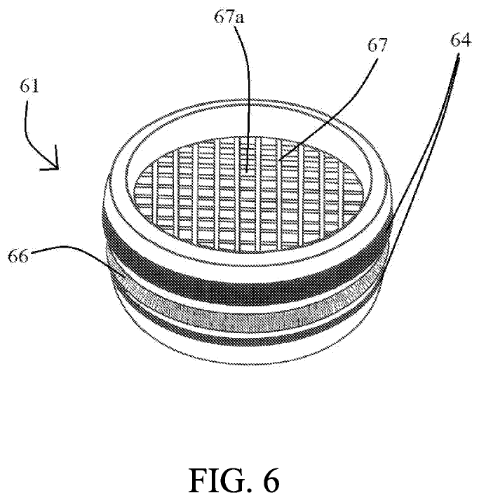

FIG. 6 shows a perspective view of one embodiment showing the coupler 61. The coupler comprises two gaskets 64 designed to fit in the top part and the bottom part. The coupler 61 also has a strainer 67 with the appropriately sized holes 67a that are designed to allow the liquid drink to pass through the strainer 67 without allowing big pieces of ice and/or plants such as mint to pass. The coupler 61 also has knurled edging 66 which allows the drink maker to better grip the coupler 61.

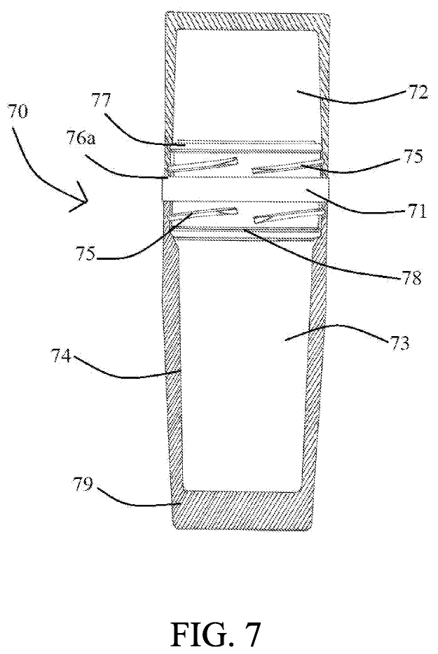

FIG. 7 shows a cross-sectional view from the side of the shaker 70. The coupler 71 is of a size that goes from the strainer 77 to the opening 78 of the bottom part 73. It should be noted that the top part 72 is of a different shape and a different volumetric capacity relative to the bottom part 73 with the bottom part 73 being tapered and the top part 72 of a shape that is not tapered. The sizes and the shapes of the top part and the bottom part may be the same or different.

The coupler 71 shows screw threads 75 that allow the top part 72 and the bottom part 73 to be attached to the coupler 71 with the top part 72 and the bottom part 73 have the appropriately reciprocal screw threads that allow the coupler 71 to be screwed onto the top part 72 and the bottom part. The inner surface 74 of the bottom part 73 may be composed of a different material (such as copper) relative to the material of the rest of the bottom part 73 (which may be stainless steel, for example). Insulated area 79 provides the bottom part 73 with the ability to keep cold liquids cold and hot liquids hot (the top part 72 has a corresponding insulated area, which provides the same effect). The insulated area may contain a vacuum or may contain a solid insulating material.

It should be noted that horizontal ledge 76a provides the coupler 71 with a circular ledge that acts as a stopping point for the top part 72 so that top part 72 when screwed onto the coupler 71 causes horizontal ledge 76a to abut the rim of top part 72, causing a good and tight seal. Similarly, the rim of bottom part 73 abuts the horizontal ledge on the bottom side of coupler 71. It should be understood that either the top part 72 or the bottom part 73 can be unscrewed from the coupler 71 at any point in time to have the coupler 71 attached to the part that has not been unscrewed. Although not shown in FIG. 7, it should be understood that two strainers (one strainer 77 is shown) can be part of the coupler 71, with one strainer 77 adjacent to the screw threads 75 on the top part 72 and the second strainer on the lower part of the coupler 71 adjacent to the screw threads 75 on the bottom part 73. In a variation, the two strainers may have the same size or different size holes.

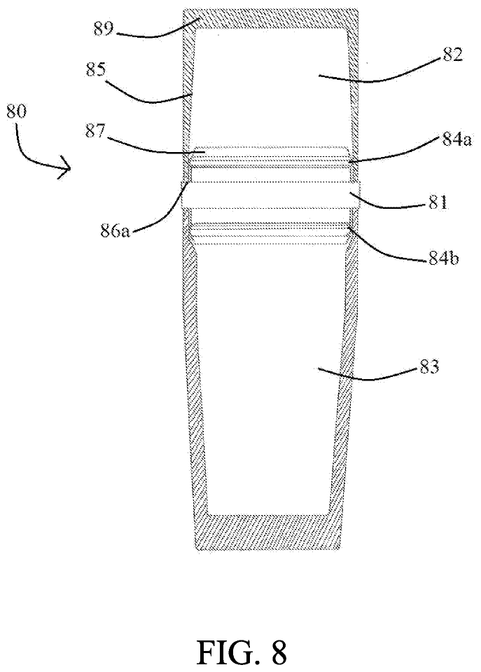

FIG. 8 shows a cross-sectional view of another embodiment of a shaker 80. In FIG. 8, the coupler 81 couples the top part 82 with the bottom part 81 via the use of gaskets 84a, 84b to frictionally attach the top part 82 to the coupler 81 and the bottom part 83 to the coupler 81. Similarly to FIG. 7, the upper part 82 may contain an inner surface 85 that comprises a separate material from the rest of the upper part 82. The upper part 82 may also have an insulated area 89 that provides the upper part 82 with enhanced ability to maintain temperatures. The insulated area 89 may be comprised of a vacuum or alternatively, a solid material with good insulating abilities. The bottom part 83, in an embodiment, has an equivalent insulated area and insulating ability. It should be noted that although it is not shown in FIG. 7 nor in FIG. 8, the coupler may have knurling edging that provides the drink maker with a gripping surface that prevents the shaker 80 from being easily dropped.

In an embodiment, the present invention relates to a coupler that is configured and designed to couple a first insulated container to a second insulated container, the first insulated container comprising a top part and the second insulated container comprising a bottom part, said coupler comprising one or more gaskets and/or one or more screw threads, wherein the one or more gaskets are positioned so as to be able to frictionally couple and operationally attach the top part to the coupler and/or the bottom part to the coupler, said one or more screw threads being positioned to allow the top part to be screwed onto and operationally attached to the coupler and/or to allow the bottom part to be screwed onto and operationally attached to the coupler.

In a variation, the coupler further comprises a strainer. In a variation, the coupler further comprises knurling edging. In a variation, the coupler comprises stainless steel. In a variation, the coupler further comprises plastic, rubber, or glass. In an embodiment, the coupler uses screw threads to couple the coupler to the top part and the bottom part. In a variation, the coupler uses gaskets to couple the top part to the coupler and the bottom part to the coupler. In an embodiment, the coupler uses both one or more gaskets and one or more screw threads to couple of the coupler to the top part and to couple the coupler of the bottom part.

In a variation, the coupler comprises a ring shape having an inner circumference and an outer circumference, the one or more screw threads present on the outer circumference of the coupler and designed to fit inside an inner circumference of the top part and an inner circumference of the bottom part. In a variation, the coupler comprises gaskets on the outer circumference of the coupler that are designed to fit in the inner circumference of the top part and the inner circumference of the bottom part. In a variation, the one or more screw threads may be present on the outer circumference of the top part and the outer circumference of the bottom part so that the top part screws into appropriately reciprocal threads on the inner circumference of the coupler.

In a variation, the inner circumference of the coupler further has a strainer that is operationally connected to the inner circumference of the coupler.

In an embodiment, the present invention relates to a shaker that comprises a top part, a bottom part, and a coupler, said coupler configured and designed to couple a first insulated container to a second insulated container, the first insulated container comprising the top part and the second insulated container comprising the bottom part, said coupler comprising one or more gaskets and/or one or more screw threads, wherein the one or more gaskets are positioned so as to be able to frictionally couple and operationally attach the top part to the coupler and/or the bottom part to the coupler, said one or more screw threads being positioned to allow the top part to be screwed onto and operationally attached to the coupler and/or to allow the bottom part to be screwed onto and operationally attached to the coupler.

In a variation, the shaker may further comprise a strainer. In a variation, the shaker may further comprise knurling edging. In a variation, the knurling edging may be present on any of the coupler, the top part, and the bottom part, or on any combination thereof.

In a variation, the shaker comprises one or more of stainless steel, plastic, rubber, or copper. In a variation, the first insulated container and the second insulated container comprise stainless steel and copper. In a variation, the coupler comprises stainless steel or plastic, or a combination of stainless steel and plastic.

In an embodiment, the present invention relates to methods of making the shaker, methods of using the shaker, and methods of making the coupler.

In one variation, the present invention relates to a method of mixing and/or preparing a drink, comprising adding drink components to a shaker, said shaker comprising a top part, a bottom part, and a coupler, said coupler configured and designed to couple a first insulated container to a second insulated container, the first insulated container comprising the top part and the second insulated container comprising the bottom part, said coupler comprising one or more gaskets and/or one or more screw threads, wherein the one or more gaskets are positioned so as to be able to frictionally couple and operationally attach the top part to the coupler and/or the bottom part to the coupler, said one or more screw threads being positioned to allow the top part to be screwed onto and operationally attached to the coupler and/or to allow the bottom part to be screwed onto and operationally attached to the coupler, shaking the drink components, and optionally pouring the drink components into a drink receptacle.

In one variation, the drink is a martini, mojito or a mint julep. In one variation of the method, the shaker further comprises one or more of a strainer and knurling edging. In a variation, the strainer is present and the strainer is used to filter the mint or olives.

In a variation of the method, the drink is coffee or tea and the strainer is used to filter coffee grounds or tea leaves.

The present disclosure is described above and in the accompanying drawings with reference to multiple examples. The purpose served by this disclosure is to provide examples of various features and concepts related to the invention and not to limit the scope of the invention. One skilled in the relevant art will recognize that numerous variations and modifications may be made to the examples described above without departing from the scope of the present invention. Any feature that is described herein can be combined with any other feature as long as those features are not incompatible with each other.

The following references are incorporated by reference in their entireties for all purposes.
U.S. Pat. No. 4,872,764 A* Oct. 10, 1989 McClean Cocktail Shaker
U.S. Pat. No. 6,913,165 B2* Jul. 5, 2005 Linz Cocktail Shaker
U.S. Pat. No. 7,571,830 B2* Aug. 11, 2009 Lin Beverage Shaker With Ice Strainer
U.S. Pat. No. 7,896,189 B2* Mar. 1, 2011 Griffin Combination Drink Dispenser
U.S. Pat. No. 7,959,346 B2* Jun. 14, 2011 Loden Drink Shaker Having Breaking Protrusions
2011/0220605 A1* Sep. 15, 2011 Chapple Drink Bottle
2012/0147,693* Jun. 14, 2012 Bahlenhorst Ice-Shaving Cocktail Shaker
8,490,822 B1* Jul. 23, 2013 Griffin Combination Drink Dispenser
9,714,121 B2* Oct. 23, 2014 Gamelli Beverage Container
2015/0216361 A1* Aug. 6, 2015 Tsui Device and Method for Mixing Drinks
9,723,956 B2* Aug. 8, 2017 David Device, Arrangement and Method for Texturizing and Aerating Drink
US Patent Application Publication No. 2020/0377273 A1* Dec. 3, 2020 Seiders Closure and Lid Method of Forming Closure and Lid
DE202011000195U1* Nov. 15, 2011 Devpat Combination of a Lid and a Strainer for a Shaker

I claim:

1. A coupler that is configured and designed to couple a first insulated container to a second insulated container, the first insulated container comprising a top part and the second insulated container comprising a bottom part, said coupler comprising one or more gaskets and/or one or more screw threads, wherein the one or more gaskets are positioned so as to be able to frictionally couple and operationally attach the top part to the coupler and/or the bottom part to the coupler, said one or more screw threads being positioned to allow the top part to be screwed onto and operationally attached to the coupler and/or to allow the bottom part to be screwed onto and operationally attached to the coupler.

2. The coupler of claim 1, wherein the coupler further comprises a strainer.

3. The coupler of claim 1, wherein the coupler further comprises knurling edging.

4. The coupler of claim 1, wherein the coupler comprises stainless steel.

5. The coupler of claim 1, wherein the coupler further comprises plastic, rubber, or glass.

6. The coupler of claim 1, wherein the coupler has one or more screw threads.

7. The coupler of claim 1, wherein the coupler has one or more gaskets.

8. The coupler of claim 1, wherein the coupler has at least one gasket and at least one screw thread.

9. The coupler of claim 1, wherein the coupler comprises a ring shape having an inner circumference and an outer circumference, the one or more screw threads present on the outer circumference of the coupler and designed to fit inside an inner circumference of the top part and an inner circumference of the bottom part.

10. The coupler of claim 9, wherein the inner circumference of the coupler further has a strainer that is operationally connected to the inner circumference of the coupler.

11. A shaker that comprises a top part, a bottom part, and a coupler, said coupler configured and designed to couple a first insulated container to a second insulated container, the first insulated container comprising the top part and the second insulated container comprising the bottom part, said coupler comprising one or more gaskets and/or one or more screw threads, wherein the one or more gaskets are positioned so as to be able to frictionally couple and operationally attach the top part to the coupler and/or the bottom part to the coupler, said one or more screw threads being positioned to allow the top part to be screwed onto and operationally attached to the coupler and/or to allow the bottom part to be screwed onto and operationally attached to the coupler.

12. The shaker of claim 11, wherein the shaker further comprises a strainer.

13. The shaker of claim 11, wherein the shaker further comprises knurling edging.

14. The shaker of claim 11, wherein the shaker comprises one or more of stainless steel, plastic, rubber, or copper.

15. The shaker of claim 11, wherein the first insulated container and the second insulated container comprise stainless steel and copper.

16. The shaker of claim 11, wherein the coupler comprises stainless steel or plastic, or a combination of stainless steel and plastic.

17. A method of mixing and/or preparing a drink, comprising adding drink components to a shaker, said shaker comprising a top part, a bottom part, and a coupler, said coupler configured and designed to couple a first insulated container to a second insulated container, the first insulated container comprising the top part and the second insulated container comprising the bottom part, said coupler comprising one or more gaskets and/or one or more screw threads, wherein the one or more gaskets are positioned so as to be able to frictionally couple and operationally attach the top part to the coupler and/or the bottom part to the coupler, said one or more screw threads being positioned to allow the top part to be screwed onto and operationally attached to the coupler and/or to allow the bottom part to be screwed onto and operationally attached to the coupler, shaking the drink components, and optionally pouring the drink components into a drink receptacle.

18. The method of claim 17, wherein the drink is a martini, mojito, or a mint julep.

19. The method of claim 17, wherein the shaker further comprises one or more of a strainer and knurling edging.

20. The method of claim 19, wherein the drink is coffee or tea.
